(19) United States
(12) Patent Application Publication
(10) Pub. No.: US 2009/0008335 A1
(43) Pub. Date: Jan. 8, 2009

(54) Use of Copolymers for Reducing Precipitates and Deposits from Inorganic and Organic Impurities in the Bayer Process for the Extraction of Aluminium Hydroxide

(75) Inventors: Christian FLOCKEN, Krefeld (DE); Detlef KUBOTH, Duesseldorf (DE); Rainer POESCHMANN, Toenisvorst (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ASHLAND LICENSING AND INTELLECTUAL PROPERTY LLC, Dublin, OH (US)

(21) Appl. No.: 11/547,506

(22) PCT Filed: Feb. 28, 2005
(86) PCT No.: PCT/EP05/02093

§ 371 Date: Feb. 13, 2007

(30) Foreign Application Priority Data
Apr. 2, 2004 (DE) 10 2004 017 034.7

(51) Int. Cl. C02F 1/68

(52) U.S. Cl. 210/701

(57) ABSTRACT

Use of water-soluble copolymers, said copolymers composed of monoethylenically unsaturated, acid group-bearing monomers a) and at least one hydrophobic component b) which contains unsaturated double bonds in Bayer process caustic solutions as agents for reducing precipitation and formation of scales by inorganic and organic impurities.

The invention relates to the use of copolymers of monoethylenically unsaturated, acid-group-containing monomers and unsaturated hydrophobic components to prevent or reduce inorganic and organic deposits from highly alkaline aqueous process caustic solutions.

The Bayer process (Ullmanns Enzyklopadie, 4^{th} edition, 1974) for obtaining aluminum hydroxide (aluminum trihydrate or gibbsite) from bauxite involves a technical problem which lies in the undesirable formation and accumulation of sodium alumosilicate from the raw materials being used.

In the first step of said process, bauxite is boiled with a sodium hydroxide solution to form sodium aluminate in the form of a supersaturated solution. Impurities such as iron oxides, silicates, titanium compounds are removed as insoluble components in the so-called red mud flocculation. However, there are still considerable amounts of dissolved impurities of bauxite, especially dissolved silicates and silicic acid, that remain in the sodium aluminate solution.

In the so-called stir-out process the aluminum hydroxide crystallizes from the supersaturated solution of sodium aluminate upon slow cooling, this being accelerated by addition of Al(OH)₃ seed crystals. The demanded particle sizes below 45 μm are normally below 10 wt.-%, and those below 90 μm make up for 55 to 65 wt.-%. In particular, as the fraction of fine particles increases, the subsequent drying process is massively slowed down. About 70 to 80% of the finely particulate aluminum hydroxide crystals obtained are re-fed as seed crystals into the process, and this would therefore give rise to undesirable accumulation of the fine particles.

In the Bayer process, the used sodium hydroxide solution obtained following crystallization (spent liquor) is recycled, thereby giving rise to accumulation of inorganic and organic components.

The composition of the bauxite varies depending on the area of origin of the bauxite ore. In general, bauxite consists of oxides and hydroxides of aluminum and iron and includes silicic acid, titanium dioxide and a large number of inorganic and organic impurities such as oxides of vanadium, chromium, phosphorus, arsenic, fluorine, sulfur, calcium, manganese, copper, zinc, beryllium, gallium and rare earths and frequently organic components such as humic acids as by-components.

During the boiling process, silicates and also some SiO₂ dissolve in the hot sodium hydroxide solution. The soluble silicates (e.g. kaolin) react with sodium aluminate and soda to form insoluble compounds. Such insoluble compounds consist of sodium alumosilicate sometimes referred to as “desilication products” (DSP) in the literature, which deposit in the form of a scale in containers and pipes of the process systems.

With respect to their chemical composition, the DSP coatings are highly variable depending on the particular procedure and from one production site to another. Also, temperature and caustic solution composition have an influence on the composition of the scales.

In many cases, however, DSPs are physical mixtures of various compounds, so that deviations in composition are normal. Thus, several layers of varying composition may grow one on top of the other, and these may also include iron- and titanium-containing scales in addition to calcium carbonate.

Some of these undesirable inorganic components are removed in the course of a previous desilication of the bauxite slurry following wet grinding, wherein the slurry is allowed to stand at high temperature for several hours. During this time, silicate-containing by-components undergo crystallization, causing the SiO₂ content of the caustic solution to decrease. Another portion of the by-components is removed from the system during red mud flocculation. However, some soluble silicate components still remain in the process caustic solution, giving rise to undesirable formation of scales on pipes, walls and in tanks of the entire production plant, which especially involves heat exchangers, of course.

Formation of scales causes considerable problems and cost as a result of higher consumption of energy, low quality of the product, complex cleaning operations, and downtimes of the production plants caused thereby.

In practice, efforts are therefore being made to prevent uncontrolled precipitation of undesirable inorganic and organic components as far as possible and shift the process of precipitation into a desilication unit in a well-directed fashion. The literature reports numerous approaches to solve said problem, especially by adding specific polymer substances to the process caustic solution. To date, however, none of these polymer additives turned out to be useful because either the effectiveness was too low or the products were unstable under the strongly alkaline conditions of the Bayer process. In particular, it should be noted that, due to the recycling of the process caustic solution, the additives remain in the system for a long period of time.

EP 0 582 399 A2 describes a method of altering the morphology of the precipitating silicate materials in Bayer process caustic solutions, wherein ammonium or amine compounds are supplied. The morphological changes in structure relate to rounding of corners and edges of the crystals and prevention of crystal growth. The examples reveal that relatively high metered amounts of the inventive products (500 ppm to 5,000 ppm) at about 230° C./30 min are required. For the purpose mentioned above, the method of EP 0 586 070 μg utilizes polymeric quaternary ammonium compounds, e.g. poly-DADMAC or polyacrylamides. Due to the alkaline conditions of the Bayer process caustic solution, such compounds have only limited stability.

With respect to the Bayer process, WO 97/41075 describes the morphology change of scales based on DSP, titanates and silicates. What is claimed therein is the use of a hydroxamic acid polymer having an average molecular weight of 1,000 to 10,000.

According to U.S. Pat. No. 5,415,782, high-molecular weight polyacrylamides or acrylamide/acrylic acid copolymers are employed to alter the morphologic properties. The altered morphologic properties of these silicate-containing materials cause a reduced tendency of deposition in the modified form on the surfaces of the system during the process.

Described in the method of WO 02/070411 is the use of copolymers of 30-99 wt.-% ethylenically unsaturated carboxylic acids and 1-70% isobutyl (meth)acrylates to reduce scales caused by alkaline recycle caustic solutions. The alkaline process caustic solution is in contact with metallic surfaces, formation of scales preferentially taking place on scales already present, thereby reducing the surface covering on the metal surface.

WO 2004/003040 A1 describes water-soluble, acid group-bearing copolymers including hydrophobic portions from the group of unsaturated hydrocarbons and terpenes, among others, as well as the use thereof in hydrous systems to avoid organic/inorganic deposits, among other things, or as dispersing aids for pigments.

The object of the invention was therefore to provide an additive agent for use in the Bayer process, which is stable under the conditions of the strongly alkaline Bayer process caustic solution and reduces or, if possible, prevents both precipitation of scale-forming substances from the caustic solution and deposition thereof on the surfaces. Furthermore, said agent is intended to suppress the formation of firmly adhering scales so as to reduce the efforts in cleaning the surfaces. Moreover, said agent is to have an effect on the crystallization process of aluminum hydroxide in a sense of higher purity and improved particle distribution.

Said object was accomplished by using water-soluble copolymers composed of monoethylenically unsaturated, acid-group-containing monomers a) and at least one of the following hydrophobic components b) which contain unsaturated double bonds
b1) an acyclic, monocyclic and/or bicyclic terpene, especially a terpene hydrocarbon,
b2) an unsaturated, open-chain or cyclic, normal or isomeric hydrocarbons with 9 to 30 carbon atoms,
b3) an unsaturated fatty alcohol or an unsaturated fatty acid with respectively 8 to 30 carbon atoms, and esters thereof with saturated aliphatic alcohols, amines and acids
   in the Bayer process caustic solutions as agents for reducing precipitation and formation of scales by inorganic and organic impurities.

The acid-group-containing unsaturated monomers a) which constitute the copolymers to be used according to the invention are selected from monocarboxylic acids such as acrylic acid, methacrylic acid, crotonic acid, isocrotonic acid, vinylacetic acid, maleic semi-esters, maleic semi-amides, dicarboxylic acids such as maleic acid, fumaric acid, itaconic acid, and sulfonic acids such as vinylsulfonic acid, allylsulfonic acid, (meth)allylsulfonic acid, 2-acrylamido-2-methyl-1-propanesulfonic acid.

It is preferred to use monocarboxylic acids, especially those selected from the group of acrylic acid, methacrylic acid and vinylacetic acid. Particularly preferred among said monocarboxylic acids is acrylic acid.

Where sulfonic acids are present, they are preferably selected from the group of vinylsulfonic acid, (meth)allylsulfonic acid and 2-acrylamido-2-methyl-1-propanesulfonic acid.

In another, preferred embodiment the copolymers to be used according to the invention include a combination of monocarboxylic acids and monomers containing sulfonic acid groups, the percentage of monomers containing sulfonic acid groups being from 0.1 to 40 wt.-%, preferably from 1 to 25 wt.-%.

The acid groups in the copolymers to be used according to the invention can be partially or completely neutralized. They are normally present as alkali or ammonium or amine salts, with alkali salts being preferred.

In a preferred embodiment their neutralization level is 1 to 75%, more preferably 2 to 50%, and most preferably 5 to 30%.

Examples of b1) to be mentioned as hydrophobic components b) are natural and synthetic terpenes, e.g. pinenes such as α-pinene and β-pinene, terpinolene, limonene (dipentenes), β-terpinene, γ-terpinene, α-thujenes, sabinenes, Δ³-carenes, camphene, β-cadinene, β-caryophyllenes, cedrenes, bisabolenes such as α-bisabolene, β-bisabolene, γ-bisabolene, zingiberenes, humulene, (α-caryophyll-1-enes), α-citronellol, linalool, geraniol, nerol, ipsenol, α-terpineol, D-terpineol-(4), dihydrocarveol, nerolidol, farnesol, α-eudesmol, β-eudesmol, citral, D-citronellal, carvone, D-pulegones, piperitones, carvenones, bisabolenes, β-selinenes, α-santalenes, vitamin A, abietic acid and mixtures of these agents, as well as extracts of naturally occurring materials, such as orange terpene. Preferred among terpenes are pinenes, nerol, citral and citronellal, camphene, limonene/dipentenes and linalool. Particularly preferred are limonene/dipentenes and pinenes.

Examples to be mentioned as unsaturated hydrocarbons b2) are decene, hexadecene, and examples to be mentioned as b3) are fatty acid monoalkyl esters, fatty acid amides or fatty acid monoalkylamides of unsaturated fatty acids, mono- or polyesters of unsaturated fatty acids with polyols, with the exception of polyethylene glycols, mono- or polyamides of unsaturated fatty acids, and aliphatic polyamines with two to six nitrogen atoms, oleic acid, octyl oleate, glycerol mono- and trioleate, and sorbitan oleates.

The percentage of component b) in the copolymer generally is about 0.01 to 30 wt.-%, preferably about 0.1 to 20 wt.-%, with 0.2 to 10 wt.-% being particularly preferred.

In addition, in order to modify the properties, up to 40 wt.-% of other comonomers c) free of acid groups can be incorporated by polymerization in the copolymers to be used according to the invention. In this context, acrylic and methacrylic esters and amides or substituted N-alkylamides may be mentioned as examples.

The weight-average molecular weights Mw of the copolymers according to the invention range from 750 to 500,000 g/mol, preferably from 1,000 to 100,000 g/mol, and more preferably between 1,500 and 10,000 g/mol.

The polymers to be used according to the invention are usually added to the Bayer process caustic solution in the form of aqueous solutions.

The polymers to be used according to the invention are produced according to methods well-known to those skilled in the art, e.g. according to the process of free-radical polymerization in aqueous phase.

Surprisingly, the polymers to be used according to the invention were found to have a very good scale-preventing effect in the highly alkaline process caustic solutions of the Bayer process for the production of aluminum hydroxide. Prevention of scales not only relates to the so-called DSPs, but rather to any type of scales, such as insoluble Ca and Mg compounds, iron-containing scales and titanium compounds. The precipitations being formed no longer undergo deposition or only to a minor extent and can easily be removed with little mechanical effort. Furthermore, the use of the polymers to be employed according to the invention results in a quantitative reduction of precipitations of scale-forming substances.

It is particularly surprising that the products according to the invention are capable of changing the composition of the DSP scales. The substrate-controlled crystallization of DSP on metal surfaces which is described in the literature is one of the mechanisms of scale formation. However, it has been found that the mechanism of crystallization of the scale-forming substances from solution is influenced without involvement of metal surfaces when using the polymers of the invention. The reduction of scales is accompanied by a change in the chemical composition of the scales. Thus, it is possible to reduce the SiO₂ content from 40 to 20% in the DSP, while the carbonate percentage in the DSP is simultaneously reduced from 4-7% to 2-3%.

It is also surprising that addition of the polymers of the invention in the subsequent stir-out process does not reduce the yield of crystallized aluminum hydroxide, although they are actually incorporated as substances preventing precipitation. The particle size distribution of the aluminum hydroxide being formed is favorably influenced, i.e., the percentage of fines is reduced in favor of the percentage of coarser matter. The purity of the crystallized aluminum hydroxide is improved by the inventive polymers because there is less precipitation of scale-forming substances in the crystallization stage.

In the course of red mud flocculation and separation it has been noted that the polymers to be used according to the invention also cause an advantageous liquefaction of the red mud which, following precipitation thereof, is present in the form of concentrated aqueous suspensions difficult to handle. By virtue of the polymers described above, these approximately 45 to 70 wt.-% muds are better in handling and thus easier to dispose of.

The polymers to be used according to the invention can be dosed into the Bayer process caustic solution at any stage of the process. As a result of recycling the process caustic solution, wherein part of the polymers are entrained, optimum dosing means replacing that part of the polymer discharged at other stages of the process. In a preferred embodiment, dosing is effected immediately upstream of heat exchangers or evaporators.

To achieve of a good effect, the polymer to be used according to the invention should be present in the process caustic solution in amounts of from 1 ppm to 5,000 ppm, preferably from 50 to 500 ppm.

Without intending to be limiting, the invention will be explained in more detail with reference to the following examples.

### EXAMPLES

### Production of an Artificial Spent Liquor

Sodium hydroxide pellets and sodium carbonate are placed in a beaker with soft water one after the other and dissolved with stirring, the temperature being raised to 108° C. Stirring is continued until a clear solution has formed. Thereafter, a weighed amount of aluminum hydroxide is added in 4 portions. Between the additions, time is allowed to pass until the solution has turned almost clear. Following complete dissolution, the water lost by evaporation is replaced. The solution in hot state is sucked through a Blauband brand paper filter in order to remove solids still present.

Initial weights: 293.58 g of NaOH, 75.87 g of Na₂CO₃, 1782.75 g of completely desalted water, 183.75 g Al(OH)₃.

A short time before starting the test, the above artificial spent liquor is added with waterglass so as to adjust an SiO₂ concentration of 1.2 g/l.

### Test Method

A beaker is filled with 200 ml of the above artificial spent liquor, and the required amount of waterglass is added.

Following addition of the scale-preventing substances, the solution is boiled with stirring at about 108° C. in open-system for 8 hours. The water being evaporated is continuously replaced, so that the liquid level never drops by more than 5 mm.

To detect the resulting turbidity, an absorbance measurement at 440 nm is effected within the first 5 hours.

After this time, the solution is allowed to cool without stirring and filtrated through two Blauband filters. The filter residue is washed several times with completely desalted water. The filter residues are dried at 70° C. for 4 hours and weighed.

The filter residues are analyzed using inductively coupled plasma emission spectroscopy (ICP) and/or wet chemistry.

Compositions and characterization of the polymers used in the examples and comparative examples (polymers of Comparative Examples C2 to C6, polymers of the invention E1 to E6) can be inferred from Table 1 below. The polymers are typified by their monomer composition and mean molecular weight. Comparative Example C1 was carried out with no addition of polymer. Table 2 shows the results of an efficiency test with these polymers at varying concentrations of use. In each test, the amount of precipitated scale-forming substance and the composition thereof were determined.

TABLE 1

| | Polymer composition | | | | | |
|---|---|---|---|---|---|---|
| | [wt.-%] | | | | | |
| | | | Orange | DIMAPA | Hydroxamic | Mol. wt. |
| Ex. | NaACS¹ | NAMAS² | terpene | quat.³ | acid | [g/mol] |
| C1 | No polymer added | | | | | |
| C2 | 57 | | | | 43 | 700,000 |
| C3 | | | | 100 | | 360,000 |
| C4 | 100 | | | | | 8,000 |
| C5 | 100 | | | | | 3,500 |
| E1 | 79.2 | 20 | 0.8 | | | 1,800 |
| E2 | 79.2 | 20 | 0.8 | | | 1,800 |
| E3 | 79.2 | 20 | 0.8 | | | 1,800 |
| E4 | 79.2 | 20 | 0.8 | | | 3,500 |
| E5 | 79.2 | 20 | 0.8 | | | 3,500 |
| E6 | 94.2 | 5 | 0.8 | | | 3,500 |

¹Sodium acrylate,
²Sodium methallylsulfonate
³Quaternized dimethylaminopropylacrylamide

TABLE 2

| | Amount | Filtrate | | | | |
|---|---|---|---|---|---|---|
| | added | residue | Composition of precipitate | | | |
| Ex. | [ppm] | [g/200 ml] | Al₂O₃ | SiO₂ | Na₂O | CaCO₃ |
| C1 | none | 1.28 | 28 | 33 | 23 | 7 |
| C2 | 100 | 1.2 | 28 | 31 | 25 | 5 |
| C3 | 100 | 1.16 | 27 | 32 | 23 | 6 |
| C4 | 100 | 1.04 | 28 | 33 | 23 | 6 |
| C5 | 100 | 1.15 | 27 | 32 | 25 | 6 |
| E1 | 50 | 1.12 | 30 | 30 | 24 | 3 |
| E2 | 100 | 0.96 | 30 | 27 | 27 | 3 |
| E3 | 200 | 0.92 | 30 | 28 | 26 | 3 |
| E4 | 100 | 0.89 | 30 | 26 | 27 | 4 |
| E5 | 200 | 0.82 | 33 | 24 | 28 | 2 |
| E6 | 100 | 0.92 | 31 | 28 | 24 | 4 |

The test results show that the copolymers of the invention markedly reduce precipitation of scale-forming substances. The precipitations are loose in structure and have no tendency of forming firm scales. Moreover, what is most surprising is that the compositions of the precipitates are changed. More specifically, the percentages of SiO₂ and carbonate are shifted in favor of Al₂O₃. These changes are assumed to be the cause of the beneficial effects of the polymers according to the invention.

### Example 7

### Influence of the Polymers of the Invention on Aluminum Hydroxide Formation

The use of chemical aids in bauxite digestion with sodium hydroxide solution to produce aluminum hydroxide may give rise to impairment of the aluminum hydroxide crystals in the stir-out process. That is, the crystal growth will be perturbed, and the hydroxide produced is excessively fine in its grain fractions. In general, the crystal fractions <45 μm and <90 μm are used for assessment.

### Test Preparation:

Items required:
Bayer process caustic solution. Sampling immediately upstream of stir-out tank inlet (after safety filtration, e.g. Kelly filter)
Washed aluminum hydroxide crystals from production (seed crystals)
Laboratory stir-out apparatus (roll stir-out apparatus in water bath)

### Test Implementation:

One liter of Bayer process caustic solution is added with 130 g of seed crystals each time. Subsequently, 100 and 200 ppm (based on bottle content), respectively, of copolymer E3 to be used according to the invention is metered in one bottle each time. To allow better comparison of the results, 2 samples with no copolymer are prepared in the manner described above. The bottles are sealed and placed in the roll stir-out apparatus, the temperature of which is controlled by means of a water bath. The temperature of the water bath is steadily decreased from 72° C. to 62° C. over a time period of 19 hours. After completion of crystallization (or stirring) taking place in the bottles, the bottle contents are separated into liquid and solid phases by means of a vacuum suction funnel. To determine the particle sizes, the separated aluminum hydroxide is measured in wet condition using laser-optical means.

TABLE 3
Particle size distribution of the aluminum
hydroxide crystals (percentage by weight)

| | | | Addition of E3 |
|---|---|---|---|
| Fraction | Seed crystals | No aid added | 100 ppm/200 ppm |
| <45 μm | 13.3 | 8.5 | 7.3/7.5 |
| <90 μm | 68 | 56.4 | 55.7 |

The polymer used according to the invention does not have any adverse effect on the growth of aluminum hydroxide crystals in the so-called stir-out process (crystallization process) in an aluminum hydroxide production. Rather, the particle size distribution is influenced in a favorable fashion because less undesirable finely particulate crystals are being formed in favor of coarser crystals. This is surprising in that, with respect to their function, the polymers according to the invention would more likely be effective in a way of preventing precipitations.

1. Use of water-soluble copolymers, said copolymers composed of monoethylenically unsaturated, acid-group-containing monomers a) and at least one of the following hydrophobic components b) which contain unsaturated double bonds
b1) an acyclic, monocyclic and/or bicyclic terpene, especially a terpene hydrocarbon,
b2) an unsaturated, open-chain or cyclic, normal or isomeric hydrocarbon with 9 to 30 carbon atoms,
b3) an unsaturated fatty alcohol or an unsaturated fatty acid with respectively 8 to 30 carbon atoms, and esters thereof with saturated aliphatic alcohols, amines and acids
in Bayer process caustic solutions as agents for reducing precipitation and formation of scales by inorganic and organic impurities.

2. The use according to claim 1, characterized in that the monoethylenically unsaturated, acid-group-containing monomers are composed of monoethylenically unsaturated monocarboxylic acids.

3. The use according to claims 1 and 2, characterized in that the acid-group-containing monomers are chosen from the group comprising acrylic acid, methacrylic acid, vinylacetic acid, preferably acrylic acid.

4. The use according to claims 1 to 3, characterized in that the monoethylenically unsaturated, acid-groups-containing monomers are composed of monoethylenically unsaturated monocarboxylic acids and monoethylenically unsaturated sulfonic acids.

5. The use according to claims 1 to 4, characterized in that the acid groups are partially or completely neutralized.

6. The use according to claims 1 to 5, characterized in that the copolymerizable hydrophobic component is an acyclic terpene and/or a monocyclic and/or bicyclic terpene hydrocarbon.

7. The use according to claims 1 to 6, characterized in that the percentage of hydrophobic component b) in the copolymer is from 0.01 to 30 wt.-%, and the percentage of acid monomer component a) is from 99.99 to 70 wt.-%.

8. The use according to claims 1 to 7, characterized in that the copolymer has a weight-average molecular weight of from 750 to 500,000 g/mol.

9. The use according to claims 1 to 8, characterized in that the copolymer is employed in the alkaline process caustic solution in amounts of from 1 to 5,000 ppm.

10. The use according to claims 1 to 9, characterized in that the copolymer is added to the Bayer process caustic solution downstream of the aluminum hydroxide crystallization stage.

11. Use of water-soluble copolymers, said copolymers being formed of monoethylenically unsaturated, acid group-bearing monomers a) and at least one of the following hydrophobic components b) which contain unsaturated double bonds
b1) an acyclic, monocyclic and/or bicyclic terpene, especially a terpene hydrocarbon,
b2) an unsaturated, open-chain or cyclic, normal or isomeric hydrocarbon with 9 to 30 carbon atoms,
b3) an unsaturated fatty alcohol or an unsaturated fatty acid with respectively 8 to 30 carbon atoms, and esters thereof with saturated aliphatic alcohols, amines and acids
in the liquefaction of concentrated aqueous suspensions of red mud from the Bayer process for the production of aluminum hydroxide.
